(19) United States
(12) Patent Application Publication
(10) Pub. No.: US 2022/0413797 A1
(43) Pub. Date: Dec. 29, 2022

(54) Passenger Assistant for a Shared Mobility Vehicle

(71) Applicant: Cerence Operating Company, Burlington, MA (US)

(72) Inventors: Arun Kumar Kallara Rajappan, Ulm (DE); Obada Ali Taha Alaqtash, Ulm (DE); Patrick Langer, Ulm (DE); Daniel Mario Kindermann, Aachen (DE); Adam Emfield, Burlington, MA (US); Nils Lenke, Aachen (DE)

(21) Appl. No.: 17/774,917

(22) PCT Filed: Dec. 23, 2020
(86) PCT No.: PCT/US2020/066841

§ 371 Date: May 6, 2022

Related U.S. Application Data
(60) Provisional application No. 62/956,741, filed on Jan. 3, 2020.

(51) Int. Cl. G06F 3/16; G06F 3/01; G10L 17/04; G10L 17/22; G06F 9/451

(52) U.S. Cl. CPC G06F 3/167; G06F 3/011; G06F 3/017; G10L 17/04; G10L 17/22; G06F 9/453

(57) ABSTRACT

A shared mobility vehicle hosts a moving “info kiosk” that provides information assistance to potential passengers (or other individuals) and to on-board passenger. The approach is applicable to human-operated vehicles, and a particularly applicable to autonomous vehicles where no human operator is available to provide assistance.

### CROSS-REFERENCE TO RELATED APPLICATIONS

This application claims the benefit of U.S. Provisional Application No. 62/956,741, filed on Jan. 3, 2020, which is incorporated herein by reference.

### BACKGROUND OF THE INVENTION

This invention relates to an assistant for passengers of a shared mobility vehicle, and more particularly to a voice-based assistant.

Voice assistants have become increasingly prevalent in people's homes, vehicles, and in certain public spaces. A typical voice assistant monitors its environment to identify requests spoken by individuals in the environment. Identified requests are processed by the voice assistant to generate spoken response (e.g., answers to questions) or to cause actions to occur (e.g., turning on the lights).

The prototypical use case for a voice assistant includes an individual in the same environment as a voice assistant speaking a request to the voice assistant. The voice assistant receives and processes the request to formulate a response, which it presents to the individual. For example, an individual in a vehicle might say “Hey Assistant, how long until we are home?” The voice assistant would process the request and then respond to the individual with “We will be home in about 25 minutes.” There is a need to provide assistance to passengers and potential passengers of shared vehicles, such as buses.

### BRIEF SUMMARY OF THE DISCLOSURE

In one aspect, in general, a shared mobility vehicle hosts a moving “info kiosk” that provides information assistance to potential passengers (or other individuals) and/or to on-board passengers. The approach is applicable to human-operated vehicles, and also particularly applicable to autonomous vehicles where no human operator is available to provide assistance.

Examples of such an approach may include one or more of the following features.

Microphones are placed on the outside of the vehicle and used in combination with a screen or projection mechanism that allows a person from outside the vehicle to ask questions by voice and receive feedback by graphical means, text, and/or graphical user interface (GUI).

Information about the route, the traffic situation, prices and conditions of the ride, the provider and other fields of interest is provided to passengers or potential passengers.

The interior of the vehicle may have an interface in a public zone, in which others can hear the questions and answers. The vehicle may also have a private zone in which a passenger may interact privately with the system without the interaction being overheard by other passengers.

The system supports speech input in multiple languages and responds in the same language. For example, multiple automatic speech recognition systems are run in parallel and the language that produces the result with the highest confidence is selected for response. Alternatively, a separate language classifier is used and the speech recognizer for the detected language is then used. In some examples, the language determination is performed using only the wakeup-word (“Hey Cerence” “Hallo, Cerence”). As yet another alternative, the user is prompted using GUI elements alternating in time, or being displayed in parallel, suggesting using speech in different languages.

A dialog mechanism uses the aforementioned language adaptation in a turn-by-turn way, so that the language can be switched between turns. Doing the same also for multiple users, so one user can continue a dialog in his/her language

Speech of passengers within the vehicle can be monitored (“eavesdropping”) to detect the languages spoken by the passenger population, and voice outputs, announcements and displays may then be adapted accordingly to cover all and only the language spoken by the passenger population. Also, directional audio input and output may be used to target different languages to different locations within the vehicle.

The interface is not limited to voice or touch input. For example, a camera may be used to detect hand signals by approaching potential passengers (i.e., users) by using image classification technology and a camera, to delay departure of the bus, and open the doors to let the additional passenger enter. For example, such a user may be distant from the vehicle, for example, 5 m, 10 m, or more from the vehicle. Also, outside microphones may be used to listen to distant speakers, for example, allowing a potential passenger to shout/speak into the external microphones (“please wait”). Indoor microphones may also allow passengers to act as a proxy for people they see approaching outside, by telling the vehicle to wait for the approaching potential passenger.

Individualized interactions may be based on a combination of voice biometrics and potentially and computer vision; keeping track of their questions during the ride (“will I be able to catch the green line at the station”). In that way, the system learns about their interests and needs, and proactively provides information to these passengers when leaving the bus (“You have 7 minutes left to catch the green line bus, which starts 500 yards away on the right hand side”). Also, without individualization the system may collect all questions by all passengers and provide follow-up info in a “broadcast” way upon arrival at a stop/the final destination.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations

### BRIEF DESCRIPTION OF THE DRAWINGS

FIG. 1 is an outside view of a shared mobility vehicle.

FIG. 2 is an inside view of a shared mobility vehicle.

FIG. 3 is a block diagram of a passenger information system.

### DETAILED DESCRIPTION

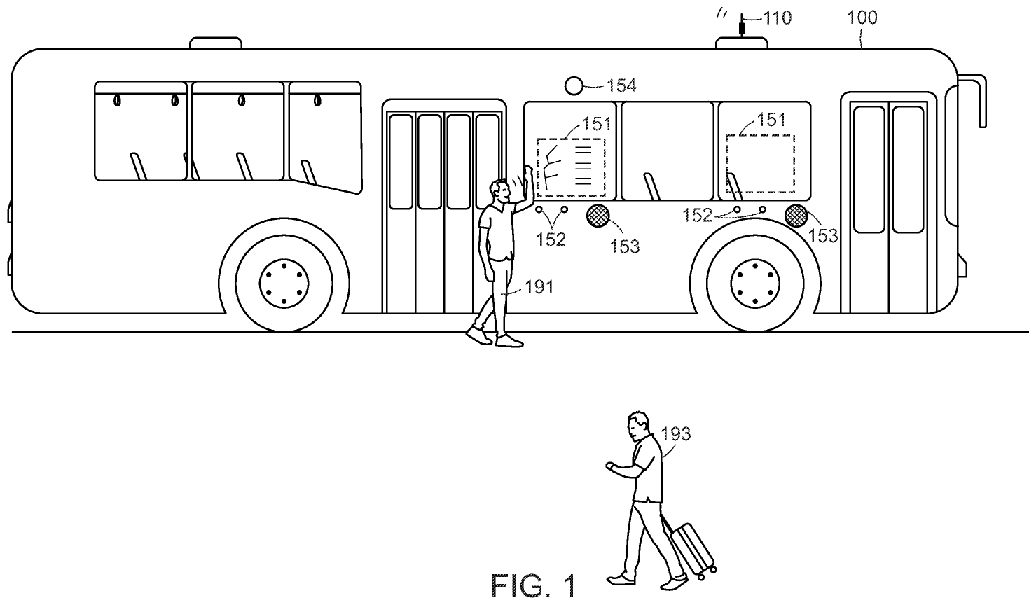

Referring to FIG. 1, an autonomous bus 100 provides transportation services to a number of passengers or potential passengers. 191, 193. These services include moving a passenger from one location to another, and also include providing information services to the passengers using an on-board information system. Because there is no driver who can answer questions, the vehicle provides an automated interface through which users interact with an information system. This information system may be referred to as a mobile “information kiosk.”

In one use case, a potential passenger 191 may approach the vehicle and speak a query to determine whether the vehicle will take him to a desired destination. For example, the user may say “Hey Mover, does this bus go to South Station?” The acoustic signal is received at one or more microphones 152 on the exterior of the vehicle, and the speech signal is processed in the system. In response, information may be presented in spoken form via a speaker 153, or in text or graphical form on a display 151. For example, the system may say “Yes, take this bus to Terminal E, and transfer to the Silver Line”, while at the same time a map may be displayed and a text version of the instructions may also be displayed. In some examples, a camera 154 may have a view of the speaker's face, and may use facial motion to aid in speech recognition via automated lip reading, and may record the user's facial features to later identify the user, for example, if the user later makes a follow-up question. In some implementations, the information system is entirely self-contained on the vehicle, but more generally, the system is in wireless communication, for example via an antenna 110, with a centralized server, which may provide information regarding schedules, traffic, and the like. In other use cases, or in further turns with the user described above, a user may use touch sensitivity of the display 154, for example, to provide entirely physical input, or mixed-mode inputs such as “How do I get here?” while touching a point on a map on the display.

In some embodiments, the system operates in a multi-lingual environment, for example, in a multilingual locality such as Switzerland where German, French, and Italian are spoken, or in an environment such as an airport, where many different languages may be spoken. In such environments, the system is configured to accept queries in multiple languages. Via the graphical display, there may be different flags or other icons that enable a user to select the language of interaction, or different displays in different corresponding languages are cycled through and the user has the opportunity to engage the system when a language in which they wish to communicate is offered. In spoken interactions, an automated language identifier is used to determine the user's language of interaction, and then audio or visual responses are presented in that language. Yet other approaches to language identification may use the camera input, for example, to attempt to determine nationality based on a user's visual appearance. In some implementations, the system supports mixed language input, for example, in localities in which a user might mix languages in a single utterance, such as “Do you go to the hotel de ville near the vieux port?”

It should be understood that the information services provided by the vehicle are not necessarily restricted to transportation related information. For example, busses in a city may provide general tourist information (“where is the nearest restaurant?”), public service information (“is the motor vehicle registry near here still open?”), and the like.

The system is not limited to interacting with users in close proximity to the vehicle. For example, the camera 154 may capture a potential passenger 193 running to catch the vehicle before it leaves, and/or hear them yell “Wait for me!”, and be able to act accordingly, for example, by delaying a departure from a stop until they get to the vehicle.

As shown in FIG. 1, a single vehicle may have multiple locations (interface stations) at which users can interact, for example, with one location being near a rear entrance and another near a front entrance to the vehicle.

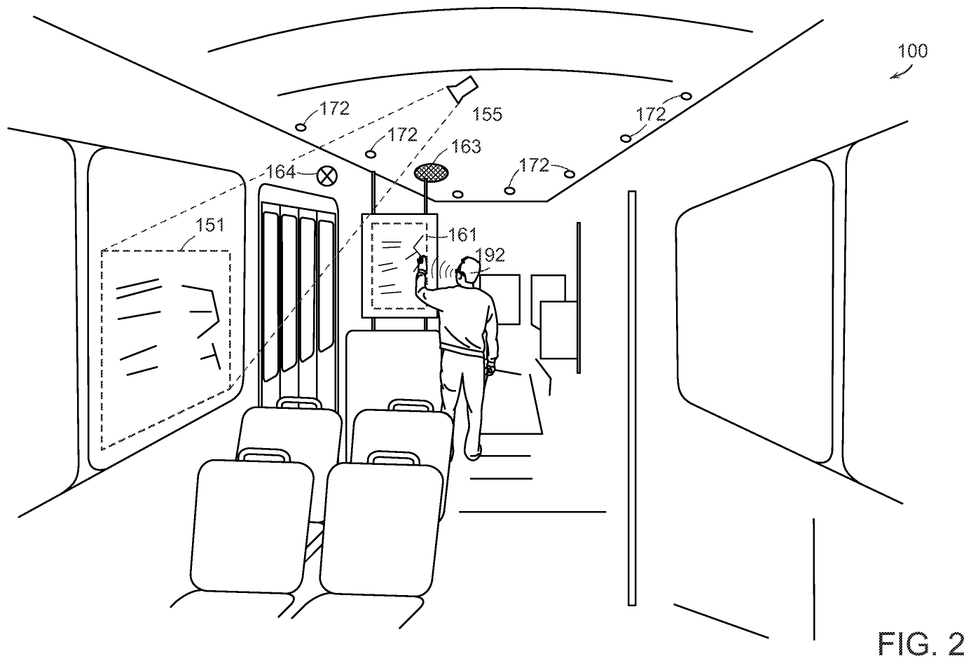

Referring to FIG. 2, the vehicle may in addition or alternatively have an inside display 161, and corresponding microphones 172, speaker 163, and camera 164, via which a passenger 192 may interact with the information system. In some examples, such a door station may be out in the open, for example, near a door through which passengers enter and exit the vehicle. In alterative or additional examples, a station may be in an alcove (not shown) or otherwise provide the passenger with private interaction with the system. Also, a handset may be used so that others do not easily hear a spoken interaction between the passenger and the system.

Note that the system uses the location context to interact with passengers. For example, if a passenger asks for confirmation “Am I on the right bus for South Station?” the vehicle may respond, “Yes, in two stops exit the bus and wait for the Silver Line, which should arrive in 4 minutes after we get there.”

As introduced above, the system may remember a user context, for example based on the user's voice characteristics, facial image characteristics, or perhaps electronic characteristics such as identifying information emitted from the user's smartphone, or gathered from the user by querying an identification card, such as a smart passport. In an exemplary use case, if the passenger asked a question regarding travel to a destination such as “South Station,” when the user later asks a contextual question such as “Is this my stop?” the system can answer, “No, in two stops exit and wait for the Silver Line.”

In some examples, the system may initiate an interaction with a passenger it knows is in proximity or just generally in the vehicle, for example, by providing a targeted announcement such as “Exit at the next stop for connection to South Station via the Silver Line.”

The system may include a monitoring capability, for example, monitoring in-vehicle conversations via microphones 172 distributed throughout the vehicle. This monitoring may yield information about the languages being spoken in the vehicle, and based on the determination of those languages, may adapt the selection of language in which general announcements are made. Similarly, detection of discussion about particular destinations may be used to provide targeted announcements related to such locations, such as “Next stop for connections to South Station” if the system detects discussions that include the location name “South Station.” In conjunction with the monitoring capability, or with a capability to track locations of passengers within the vehicle, in some versions of the system, system output can be directed to particular locations within the vehicle, for example, using speaker or graphical displays near those locations, or using directional sound emission. In some implementations, the monitoring system is configured to act on spoken input anywhere throughout the vehicle, such as “Next stop please.”

A variety of display technologies may be used for the display 151 and 161. For example, a projector 155 may be used to project information on an outside window (e.g., using special glass that has an internal “screen” layer) or a liquid crystal display (LCD) may be used.

Although described in the context of an autonomous vehicle, the capabilities described above are equally applicable to human operated vehicles. For example, in some long articulated busses, it may not be practical for a passenger to engage the driver in a dialog. Furthermore, the primary function of the vehicle is not necessarily transportation. For example, a tourist information kiosk may autonomously travel in a tourist area providing information to users, including travel information, but not itself transporting users.

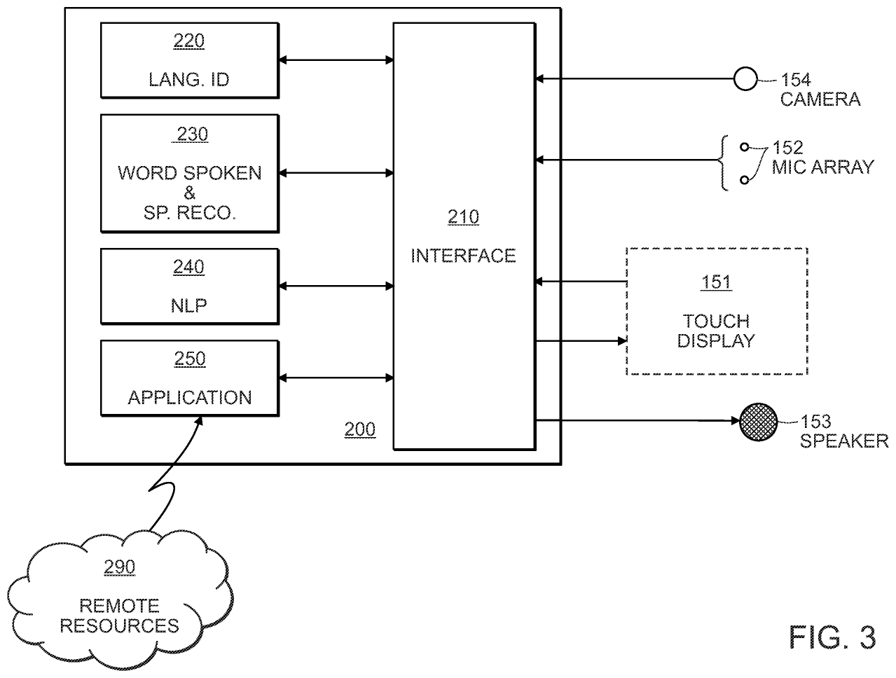

Referring to FIG. 3, in one implementation 200, the camera 154, microphone(s) 152, touch display 151 and speaker 153 are electrically or wirelessly coupled to an interface 210. The interface makes use of one or more functional components, for instance, a language identification component 220, a word spotting and speech recognition component 230, a natural language processing component 240, and one or more application components 250. For example, an application component 250 may perform trip planning, and may interact with resources 290 that are remote to the vehicle. Not shown in FIG. 3 is a computer processor on which the functional blocks of FIG. 3 may be implemented using software instructions stored on a non-transitory computer-readable medium, or special-purpose circuitry (e.g., ASICs or FPGAs) that are used to implement certain functions, such as parts of acoustic or image analysis performed by the system. In some implementations, some of the processing (e.g., speech recognition or natural language processing) may be performed remotely from the vehicle, for example, on a server computer in data communication with a processor in the vehicle.

The approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program. The modules of the program can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs) or dedicated, application-specific integrated circuits (ASICs). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

1. An apparatus for providing information services via a shared vehicle, comprising:
a user interface including at least one of a spoken language and a graphical interface, and an interaction system, responsive to interaction with users with the interface, for providing information services.

2. The apparatus of claim 1, wherein the shared vehicle is a shared transportation vehicle.

3. The apparatus of claim 1, wherein the shared vehicle is a mobile information kiosk.

4. The apparatus of claim 1, wherein the user interface is configured for user interaction inside the shared vehicle.

5. The apparatus of claim 1, wherein the user interface is configured for public access by users.

6. The apparatus of claim 1, wherein the user interface is configured for private access by one or more users.

7. The apparatus of claim 6, wherein the interface is configured to restrict access to interactions between the user interface and the one or more users.

8. The apparatus of claim 1, wherein the user interface is configured for user interaction outside the shared vehicle

9. The apparatus of claim 8, wherein the interface includes at least some interface components located on an outside surface of the shared vehicle.

10. The apparatus of claim 8, wherein the user interface is configured for receiving input from a user at a distance of at least 5 meters.

11. The apparatus of claim 10, wherein receiving input from a user at a distance includes at least one of acquiring a limb motion via a camera and acquiring a voice utterance via one or more microphones.

12. The apparatus of claim 1, wherein the user interface includes a spoken language interface.

13. The apparatus of claim 12, wherein the spoken language interface comprises a multi-language interface.

14. The apparatus of claim 13, wherein the spoken language interface includes a language detector, and said interface is configured to select an interaction language according to output of the language detector.

15. The apparatus of claim 1, wherein the user interface includes a multi-modal interface.

16. The apparatus of claim 1, further comprising an in-vehicle monitoring system, and wherein the apparatus is configured according to information determined from the monitoring system.

17. The apparatus of claim 16, wherein the information determined from the monitoring system comprises at least one of a language spoken by a passenger and a location spoken about by a passenger.

18. The apparatus of claim 1, wherein the interaction system is configured to conduct multiple turn dialogs with passengers.

19. The apparatus of claim 18, wherein the system is configured to record user characteristics to identify a repeated interaction with a particular user based on the recorded user characteristics.

20. The apparatus of claim 19, wherein the user characteristics includes at least one of a voice characteristic and a facial characteristic.
